(19) United States
(12) Patent Application Publication
(10) Pub. No.: US 2025/0190221 A1
(43) Pub. Date: Jun. 12, 2025

(54) SYSTEMS AND METHODS FOR PARALLELIZATION OF EMBEDDING OPERATIONS

(71) Applicants: Advanced Micro Devices, Inc., Santa Clara, CA (US); Xilinx, Inc., San Jose, CA (US)

(72) Inventors: Krishnakumar Nair, San Jose, CA (US); Meenakshi Arunachalam, Bellevue, WA (US); John Kalamatianos, Boxborough, MA (US); Rishabh Jain, Austin, TX (US); Varun Agrawal, Bangalore (IN); Avinash Chandra Pandey, Bangalore (IN); Siddappa Yallappa Karabannavar, Bangalore (IN); Ashish Sirasao, San Jose, CA (US); Elliott Delaye, San Jose, CA (US)

(73) Assignees: Advanced Micro Devices, Inc., Santa Clara, CA (US); Xilinx, Inc., San Jose, CA (US)

(21) Appl. No.: 18/974,332

(22) Filed: Dec. 9, 2024

(30) Foreign Application Priority Data
Dec. 9, 2023 (IN) 202311084060

(51) Int. Cl. G06F 9/38; G06F 9/50; G06F 12/1072

(52) U.S. Cl. CPC G06F 9/3885; G06F 9/5038; G06F 12/1072; G06F 2209/5019; G06F 2212/2542

(57) ABSTRACT

A disclosed method may include initializing a deep learning recommendation model (DLRM) comprising a plurality of embedding tables, each embedding table comprising a plurality of embeddings. The method may also include receiving input data associated with accessing embeddings from the plurality of embedding tables and applying a parallelization strategy to process the plurality of embedding tables, the parallelization strategy configured to improve performance by distributing computational workloads and optimizing memory access. The method may also include processing the embeddings based on the input data in accordance with the parallelization strategy, the processing comprising aggregating embeddings accessed from the plurality of embedding tables. The method may also include generating, for further processing, output data based on the processed embeddings. Various other methods, systems, and computer-readable media are also disclosed.

### CROSS-REFERENCE TO RELATED APPLICATION

This application claims priority under 35 U.S.C. § 119 to Indian Provisional Patent Application No. 202311084060, filed on Dec. 9, 2023, the entire disclosure of which is incorporated herein by reference.

### BACKGROUND

Recommendation systems have become integral to various industries, driving personalized experiences for users in e-commerce, social media, and digital content platforms. These systems rely on machine learning models, often referred to as deep learning recommendation models (DLRMs), to predict user preferences based on large-scale data sets. DLRMs employ embedding tables to represent categorical data as dense numerical vectors, enabling efficient computations and accurate predictions. However, as data complexity grows, the size of embedding tables can expand significantly, leading to increased computational demands and resource utilization.

A key challenge in deploying DLRMs is the efficient handling of the embedding bag operator, which retrieves and processes embeddings from these large tables. Conventional approaches for managing the embedding bag operation often involve parallelizing workloads across multiple processors or threads. While these methods provide some level of scalability, they frequently encounter issues related to cache inefficiency, memory contention, and load imbalance. These inefficiencies can lead to suboptimal resource utilization, increased latency, and a failure to meet the stringent quality-of-service (QoS) requirements of real-time recommendation systems.

Moreover, the disparity in memory access patterns and computational characteristics between different embedding tables adds further complexity to the problem. Some tables exhibit high levels of reuse and are bound by memory bandwidth, while others are constrained by computational limitations or irregular access patterns. Traditional methods struggle to adapt to these heterogeneous workload characteristics, often resulting in bottlenecks that degrade overall system performance.

As the scale of DLRMs continues to grow, driven by larger user bases and increasingly complex models, there is a pressing need for more efficient strategies to handle the embedding bag operation. Such strategies must address the challenges of dynamic workload distribution, memory hierarchy optimization, and scalability across modern computing architectures, including multi-core and multi-socket systems. Solving these issues is critical to ensuring that DLRMs can operate efficiently, meet real-time constraints, and deliver high-quality recommendations to end-users.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system configured for parallelization of embedding operations.

FIG. 2 is a block diagram of an example implementation of a system for parallelization of embedding operations.

FIG. 3 is a flow diagram of an example computer-implemented method for parallelization of embedding operations.

FIG. 4 depicts an example block diagram of a processor architecture that may be utilized in one or more embodiments of the present disclosure to execute parallelization strategies for embedding operations in a DLRM.

FIG. 5 illustrates an embedding bag operation used in a DLRM.

FIG. 6 shows a block diagram that illustrates how one or more embodiments may apply process threading and batch threading strategies to optimize embedding operations in DLRMs.

FIG. 7 shows a block diagram that illustrates a table threading parallelization strategy, a method of distributing computational workloads across processing cores in a DLRM.

FIG. 8 includes a block diagram that illustrates a hierarchical threading parallelization strategy.

Throughout the drawings, identical reference characters and descriptions indicate similar, but not necessarily identical, elements. While the examples described herein are susceptible to various modifications and alternative forms, specific implementations have been shown by way of example in the drawings and may be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The technical problem addressed by the present disclosure arises from the inefficiencies and limitations associated with managing the embedding bag operator in DLRMs. The embedding bag operator performs sparse vector lookups across large embedding tables to retrieve data needed for model computations. These tables, which grow with the increasing complexity of DLRMs and the scale of user interactions, present challenges related to computational load distribution, memory bandwidth utilization, and cache management. Existing solutions often fail to address the highly heterogeneous nature of embedding table workloads, leading to significant performance bottlenecks and resource underutilization.

One primary challenge involves the imbalance in computational and memory access patterns across embedding tables. Some embedding tables experience frequent reuse of certain indices, which can benefit from optimized cache hierarchies, while others require random access patterns that stress memory bandwidth and latency. In addition, processing these embedding tables in parallel often results in uneven workload distribution, as embedding tables vary in size, pooling factors, and access frequencies. This imbalance leads to inefficiencies, such as idle processing threads, underutilized cores, and frequent cache thrashing, all of which negatively impact system throughput and latency.

Embodiments of the present disclosure provide a technical solution by introducing specific parallelization strategies that dynamically allocate computational resources to embedding tables based on workload characteristics. By employing techniques such as table threading (TT), core group table threading (CGTT), hierarchical threading (HT), and hybrid table grouping (hybrid TG) with HT, embodiments of the present disclosure may tailor resource allocation to the unique requirements of each embedding table. These strategies may optimize cache reuse, minimize memory contention, and balance workloads across processing cores, addressing the inefficiencies seen in earlier approaches. For example, hybrid TG and HT allow larger tables with high reuse rates to be processed using multiple cores, while smaller tables or those with less frequent access are handled by single cores, achieving an optimal balance of computational and memory resources.

At least one technical result achieved by embodiments of the present disclosure may include an improvement in the overall performance of DLRMs, as measured by increased throughput, reduced latency, and efficient utilization of computational and memory resources. These advancements may enable DLRMs to process increasingly complex models and larger datasets, ensuring real-time recommendations while meeting strict quality-of-service requirements. By addressing the specific challenges posed by embedding table workloads with specific, scalable solutions, embodiments of the present disclosure may transform the efficiency and scalability of DLRM pipelines in data-intensive applications.

The present disclosure is generally directed to systems and methods for improving the parallelization of embedding bag operations in DLRMs. As will be explained in greater detail below, embodiments of the present disclosure may enhance the functioning of computing systems by dynamically distributing workloads across hardware resources in a manner that optimizes computational throughput and memory efficiency. By leveraging specific parallelization strategies, such as TT, HT, and hybrid TG, embodiments may reduce cache contention, improve load balancing, and/or maximize bandwidth utilization. This may result in significant improvements in processing efficiency and responsiveness for DLRMs, enabling them to handle larger and more complex datasets while meeting strict latency requirements.

Embodiments of the present disclosure may not only enhance the functioning of the computer systems on which they operate by enabling more efficient utilization of CPU and memory resources but may also improve the performance and scalability of recommendation systems, a key technology in fields such as e-commerce, digital advertising, and personalized content delivery. For example, by tailoring computational strategies to workload characteristics, embodiments of the present disclosure may facilitate faster processing of embedding tables and enable the deployment of larger models that achieve greater accuracy in recommendations. These advancements may transform technical capabilities of recommendation systems, making recommendation systems more adaptive and responsive in real-world, data-intensive environments.

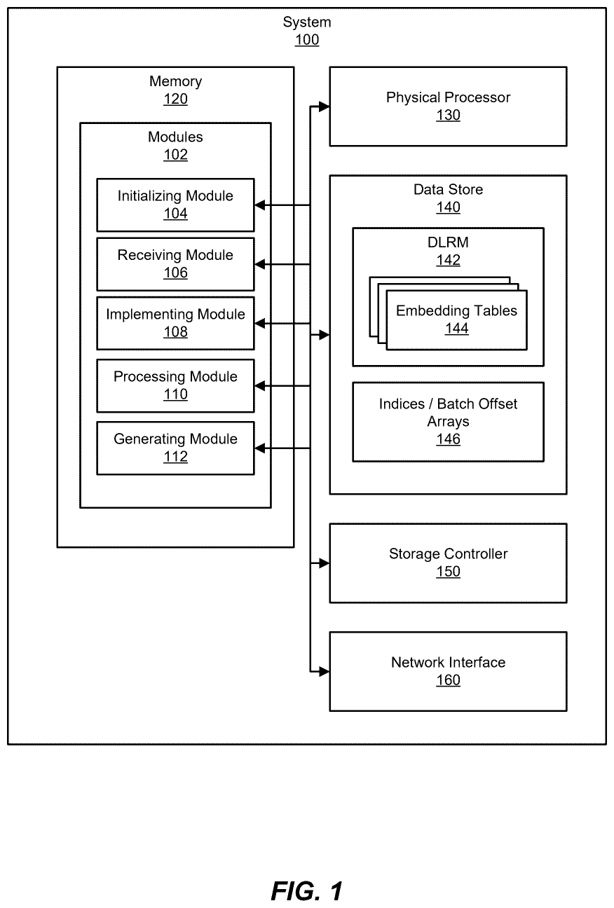

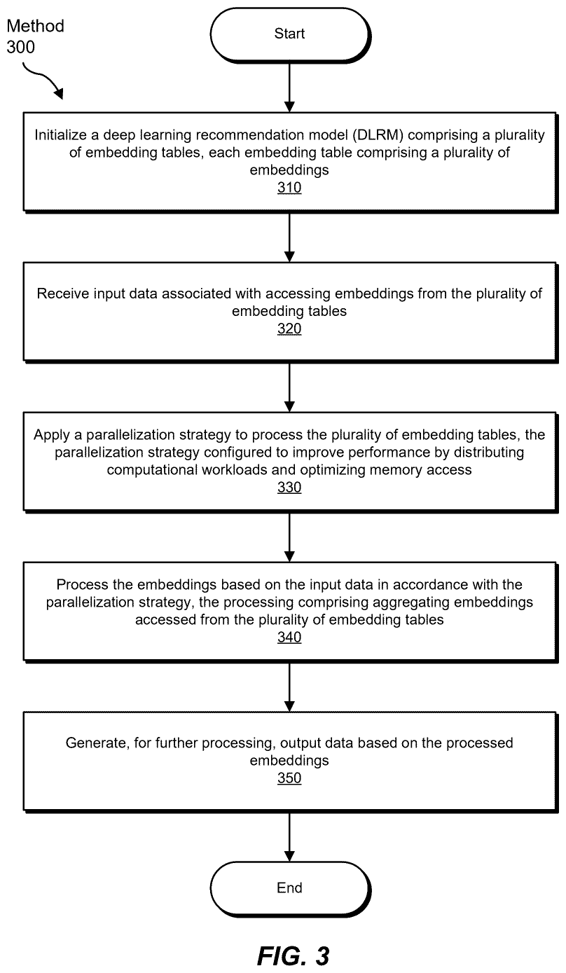

The following will provide, in reference to FIGS. 1-2 and 4-8, detailed descriptions of systems for parallelization of embedding operations. Additionally, detailed descriptions of methods for parallelization of embedding operations will be provided below in reference to FIG. 3.

FIG. 1 is a block diagram of an example system 100 configured for parallelization of embedding operations. As shown, example system 100 may include one or more modules 102 to perform specific tasks. Modules 102 may include an initializing module 104 that initializes a DLRM that may include a plurality of embedding tables, each embedding table including a plurality of embeddings. Modules 102 may also include a receiving module 106 configured to receive input data associated with accessing embeddings from the plurality of embedding tables. For example, the input data may include indices for accessing embeddings from the embedding tables and/or corresponding batch offset arrays that define the boundaries for the indices.

Modules 102 may further include an implementing module 108 that applies a parallelization strategy to process the plurality of embedding tables. The parallelization strategy may be configured to improve performance by distributing computational workloads and/or optimizing memory access. For example, the parallelization strategy may dynamically balance computational loads and/or may optimize memory access patterns, thereby improving the overall performance of the DLRM. Additionally, a processing module 110 may process embeddings based on the input data (e.g., received indices and/or batch offset arrays), where the processing may include aggregating (e.g., via a pooling operation) embeddings accessed from the plurality of tables.

Modules 102 may also include a generating module 112 configured to generate output data (e.g., embedding vectors for the batch of input data) based on the processed embeddings. Additionally, one or more of modules 102 may deliver the generated output data (e.g., embedding vectors) to subsequent stages of a DLRM pipeline. These modules interact with other components of example system 100 to ensure efficient execution of.

Example system 100 may also include memory 120, which represents any form of volatile or non-volatile storage capable of storing data and/or computer-readable instructions. Memory 120 may store modules 102 and other relevant data structures. Examples of memory 120 may include, without limitation, Random Access Memory (RAM), Read-Only Memory (ROM), flash memory, hard disk drives (HDDs), solid-state drives (SSDs), optical disks, caches, or combinations thereof.

Physical processor 130, as depicted, represents one or more processing units capable of executing computer-readable instructions. Physical processor 130 may access and execute modules 102 stored in memory 120 to facilitate parallelization of embedding operations. Examples of physical processor 130 may include central processing units (CPUs), microprocessors, microcontrollers, Field-Programmable Gate Arrays (FPGAs) implementing softcore processors, Application-Specific Integrated Circuits (ASICs), or combinations thereof.

Data store 140 is configured to store the data required for the operation of the DLRM. Data store 140 may represent portions of a single data store or computing device or a plurality of data stores or computing devices. In some embodiments, data store 140 may be a logical container for data and may be implemented in various forms (e.g., a database, a file, file system, a data structure, etc.). Examples of data store 140 may include, without limitation, one or more files, file systems, data stores, databases, and/or database management systems such as an operational data store (ODS), a relational database, a NoSQL database, a NewSQL database, and/or any other suitable organized collection of data.

As shown, data store 140 may contain DLRM 142, which may represent a DLRM capable of processing large-scale input data to generate personalized recommendations. Data store 140 may also include embedding tables 144 and indices 146. DLRM 142 may rely on embedding tables 144 to transform categorical input data into dense numerical vectors suitable for computational processing.

Embedding tables 144 store embeddings, which are fixed-length numerical representations of categorical inputs such as user IDs or product categories. These embeddings are organized in rows, where each row corresponds to a unique categorical value. The size of each row is determined by the embedding dimension, which defines the numerical representation's granularity. Embedding tables 144 are optimized to handle diverse workload patterns, including high-reuse tables and sparsely accessed tables. Parallelization strategies may dynamically allocate computational resources to manage these patterns efficiently, ensuring effective memory utilization and high throughput.

Indices 146 may serve as pointers to specific rows within embedding tables 144. Input data processed by the system includes indices that map categorical inputs to the corresponding embeddings stored in the embedding tables. Indices 146 operate in conjunction with batch offset arrays, which define index boundaries for processing multiple embeddings in parallel. The system aggregates retrieved embeddings using pooling operations, such as summation or averaging, to generate output embedding vectors. Prefetching techniques and cache optimization may reduce latency and improve processing efficiency, particularly for embeddings with high reuse rates.

The storage controller 150 manages retrieval, storage, and caching of data for the DLRM pipeline. It facilitates data flow between data store 140 and other components, such as processor 130 and/or modules 102. By implementing caching strategies, storage controller 150 may minimize latency and may optimize memory access. For instance, it may cache frequently accessed embeddings or indices in faster memory tiers and manage the distribution of embedding tables across multiple computational units to avoid bottlenecks. In systems employing non-uniform memory access (NUMA), the storage controller may allocate data to local nodes and dynamically adjust resource distribution to maintain efficiency.

Network interface 160 may facilitate communication between system 100 and external systems, enabling reception of input data and/or the transmission of processed outputs. It may support high-throughput data transfers, allowing the system to ingest large batches of indices and batch offset arrays while transmitting output embedding vectors or recommendation results in real time. Network interface 160 may implement secure communication protocols to ensure the integrity and confidentiality of data. This component is particularly valuable in distributed or cloud-based environments, where reliable and efficient data exchange may be critical to maintaining performance.

Together, storage controller 150 and network interface 160 support the scalable and efficient operation of the DLRM pipeline. Their roles in managing data flow, optimizing resource utilization, and enabling high-performance communication may ensure that system 100 meets the stringent requirements of modern recommendation systems, including low latency, high throughput, and adaptability to dynamic input conditions.

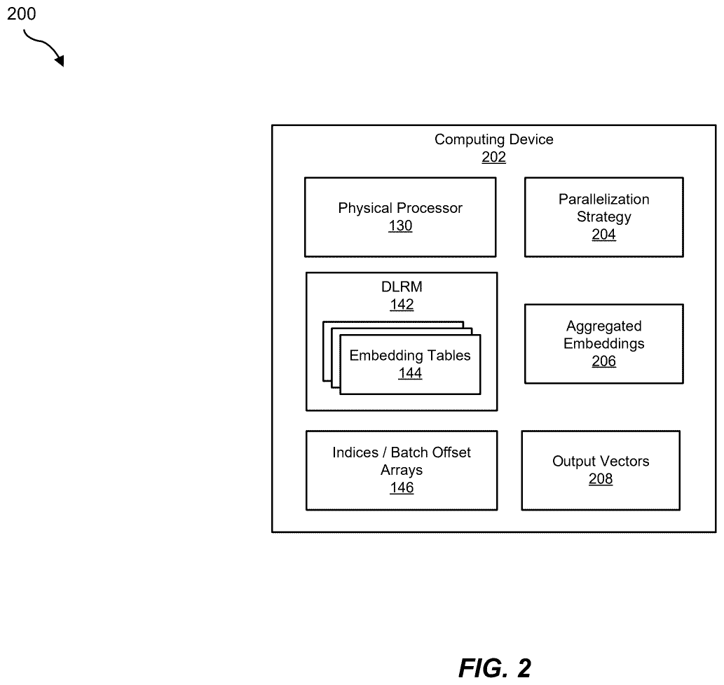

Example system 100 in FIG. 1 may be implemented in a variety of ways. For example, all or a portion of example system 100 may represent portions of an example system 200 (“system 200”) in FIG. 2. As shown in FIG. 2, system 200 may include a computing device 202. In at least one example, computing device 202 may be programmed with one or more of modules 102. Although not all shown in FIG. 2, example system 200 and/or computing device 202 may include and/or may access (e.g., via a suitable internal or external communication device and/or medium) all elements of example system 100.

In at least one embodiment, one or more modules 102 from FIG. 1 may, when executed by computing device 202, enable computing device 202 to perform one or more operations to facilitate parallelization of embedding operations. For example, as will be described in greater detail below, initializing module 104 may cause computing device 202 to initialize a DLRM (e.g., DLRM 142) that may include a plurality of embedding tables (e.g., embedding tables 144). Furthermore, receiving module 106 may cause computing device 202 to receive input data associated with accessing embeddings from the plurality of embedding tables (e.g., indices/batch offset arrays 146). Likewise, implementing module 108 may cause computing device 202 to apply a parallelization strategy (e.g., parallelization strategy 204) to process the plurality of embedding tables. The parallelization strategy may be configured to improve performance by distributing computational workloads and optimizing memory access.

Additionally, processing module 110 may cause computing device 202 to process the embeddings based on the input data in accordance with the parallelization strategy, the processing comprising aggregating embeddings accessed from the plurality of embedding tables (resulting in aggregated embeddings 206). Moreover, generating module 112 may generate, for further processing, output data (e.g., output vectors 208) based on the processed embeddings.

Computing device 202 generally represents any type or form of computing device capable of reading and/or executing computer-executable instructions. Examples of computing device 202 include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

In at least one example, computing device 202 may include or represent one or more computing devices programmed with one or more of modules 102. All or a portion of the functionality of modules 102 may be performed by computing device 202 and/or any other suitable computing system. As will be described in greater detail below, one or more of modules 102 from FIG. 1 may, when executed by at least one processor of computing device 202, may enable computing device 202 to perform one or more operations for parallelization of embedding operations.

FIG. 3 is a flow diagram of an example computer-implemented method 300 for parallelization of embedding operations. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may initialize a deep learning recommendation model (DLRM) comprising a plurality of embedding tables, each embedding table comprising a plurality of embeddings. For example, initializing module 104 may, as part of computing device 202, initialize DLRM 142, which may include embedding tables 144.

A DLRM may be a computational framework designed to predict user preferences or behaviors by analyzing large-scale data. It may consist of neural network architectures that process inputs such as user features, item features, and contextual data to generate recommendations. The model may include components such as embedding layers to transform categorical or discrete data into dense vector representations, interaction layers to combine and process these embeddings, and output layers to produce predictions or rankings. These models are often used in applications such as personalized content delivery, product recommendations, and user behavior prediction. They are optimized using objective functions tailored to recommendation tasks, such as click-through rate prediction, relevance scoring, or other performance metrics.

An embedding table is a data structure used in machine learning models to represent discrete input features, such as categorical variables, as dense vectors in a continuous vector space. Each row in the embedding table may correspond to a unique input feature or identifier, and the columns of the table may represent the dimensions of the embedding vector. Embedding tables facilitate the transformation of high-dimensional discrete input data into lower-dimensional dense representations, enabling efficient computation and improved model performance. These tables are typically stored in memory and are accessed using indices, which act as keys to retrieve specific rows corresponding to the input features. Embedding tables are commonly used in applications such as recommendation systems and natural language processing to handle sparse and high-cardinality data. As will be described in greater detail below, embedding tables may also be structured to support parallel computation, enabling efficient lookups and updates across multiple threads or cores, facilitating scalability to handle large datasets. To further enhance performance, embedding tables may be designed to optimize memory locality, reducing access latency and improving computational efficiency.

To initialize DLRM 142, initializing module 104 may perform several operations to prepare the embedding tables and other components of the model for execution. Initializing module 104 may allocate memory for each embedding table 144 in accordance with the table size and embedding dimensions. For instance, if the table size (H) represents the number of unique input features and the embedding dimension (D) represents the length of each feature vector, the total memory allocation may be proportional to H×D. To optimize memory usage and facilitate efficient data retrieval, embedding tables may be structured to align with cache hierarchies, such as L3 caches or memory associated with NUMA nodes.

If the embedding tables require pre-trained or randomly initialized embeddings, the initializing module may populate them with these values. Pre-trained embeddings may be loaded from external storage, such as a database or file, while randomly initialized values may be generated using uniform or Gaussian distributions. To reduce latency and maximize memory locality, initializing module 104 may restructure the embedding tables to align with hardware-specific memory layouts. For example, frequently accessed embedding rows (hot rows) may be stored in faster memory regions.

While the primary focus of this step is embedding tables, initializing module 104 may also set up interaction layers, which are responsible for combining embeddings. These layers may include dot products, concatenations, or other mathematical operations required by the DLRM architecture. The module may perform verification checks to ensure that all tables, indices, and parameters have been successfully initialized. If errors or inconsistencies are detected, such as insufficient memory or incorrect mappings, the module may generate an alert or log for corrective action.

Finally, initializing module 104 may log metadata about the initialized DLRM, including the number of embedding tables, the size and dimensions of each table, and memory allocation details. This metadata may be stored for debugging, benchmarking, or runtime adjustments. Upon completing these operations, initializing module 104 ensures that the DLRM is fully configured and ready for subsequent steps in the method, such as receiving input data and executing parallelized embedding operations. This setup lays the foundation for efficient processing, leveraging the system's computational resources to optimize performance and scalability.

The initialization process ensures that the DLRM is capable of handling large-scale datasets with high-cardinality features, enabling efficient processing for applications such as recommendation systems and user behavior prediction.

Returning to FIG. 3, at step 320, one or more of the systems described herein may receive input data associated with accessing embeddings from the plurality of embedding tables. For example, receiving module 106 may receive indices/batch offset arrays 146 from data store 140.

Input data in the context of DLRMs and/or parallelized embedding operations may refer to structured data used to access, process, and/or retrieve embeddings from embedding tables. This input data typically includes indices and batch offset arrays (e.g., indices/batch offset arrays 146). Indices are numeric identifiers that correspond to specific rows within one or more embedding tables, representing the discrete features or categories to be processed for a given sample in a batch. Each index directs the embedding operation to a specific location within the embedding table to retrieve the associated embedding vector. Batch offset arrays are auxiliary data structures that define boundaries within the indices, marking the start and end points of groups of indices for each sample or feature within a batch. These arrays are used to partition the indices into logical subsets that correspond to specific samples or features, facilitating efficient lookup, aggregation, and processing of embedding vectors. Together, indices and batch offset arrays enable the system to efficiently map input features to their respective embedding vectors, process these embeddings in parallel across multiple cores or threads, and produce aggregated outputs for further processing.

Receiving module 106 may operate to acquire the necessary input data required for accessing embeddings from embedding tables 144. Hence, receiving module 106 may interact with data store 140 to retrieve indices/batch offset arrays 146, ensuring that the data is available in memory for immediate processing. The indices, which may serve as pointers to specific rows in the embedding tables, are obtained and transferred into memory buffers that can be directly accessed by the processing pipelines.

To handle batch offset arrays, receiving module 106 ensures that the data is aligned and correctly segmented for each batch of input features. This involves interpreting the boundaries defined by the batch offset arrays, which dictate how the indices are grouped for parallel processing. Receiving module 106 processes these arrays to identify logical partitions of the indices, ensuring that each partition corresponds to a distinct set of features or samples. This alignment ensures that subsequent operations on the embedding tables can proceed without additional preprocessing.

Additionally, receiving module 106 verifies the integrity and completeness of the received data. For example, it may perform checks to confirm that all indices fall within the valid range for the associated embedding tables and that the batch offset arrays correctly map to the indices provided. Receiving module 106 may flag any inconsistencies, such as missing or out-of-bound indices and may initiate appropriate corrective actions to ensure the system operates without interruption.

Receiving module 106 may also optimize the organization of input data to improve data locality and minimize memory access latency during processing. For instance, indices and batch offset arrays may be reorganized to align with cache line boundaries or preloaded into specific memory regions to enhance subsequent lookup efficiency. By doing so, receiving module 106 helps streamline the computational workload that follows, reducing the time required for embedding lookups.

Receiving module 106 further handles the transfer of input data between network interface 160 and data store 140 when the data originates from external sources. In such cases, it ensures that the input data is parsed, formatted, and stored in a manner consistent with the requirements of the embedding tables and the computational architecture. This includes handling variations in data format or encoding, converting the input into the system's expected structure, and storing it in memory for immediate or future access.

Overall, receiving module 106 serves as the gateway through which input data flows into the system, ensuring that the indices and batch offset arrays are correctly prepared, validated, and positioned for efficient execution of embedding operations. Its actions are critical in setting the stage for the subsequent processing of embeddings, as the quality and organization of the received data may directly impact the system's ability to perform parallelized operations effectively.

Returning to FIG. 3, at step 330, one or more of the systems described herein may apply a parallelization strategy to process the plurality of embedding tables. For example, implementing module 108 may apply parallelization strategy 204 to process embedding tables 144. Parallelization strategy 204 may be configured to improve performance by distributing computational workloads and optimizing memory access.

As used herein, a “parallelization strategy” may include or refer to a set of techniques, methods, or processes designed to distribute computational workloads across multiple hardware resources, such as processors, cores, or threads, in a manner that optimizes performance metrics such as throughput, latency, memory access efficiency, and/or resource utilization. A parallelization strategy may involve dynamic or static allocation of tasks, synchronization of operations, optimization of memory locality, and/or balancing of computational loads to minimize bottlenecks and maximize efficiency. Examples of parallelization strategies include, but are not limited to, TT, CGTT, HT, and hybrid TG with HT, as well as strategies employing NUMA-aware techniques or workload-specific adaptive threading models. These strategies may be configured to address challenges posed by heterogeneous workloads, such as variable table sizes, pooling factors, and access patterns, to achieve efficient and scalable processing in data-intensive applications.

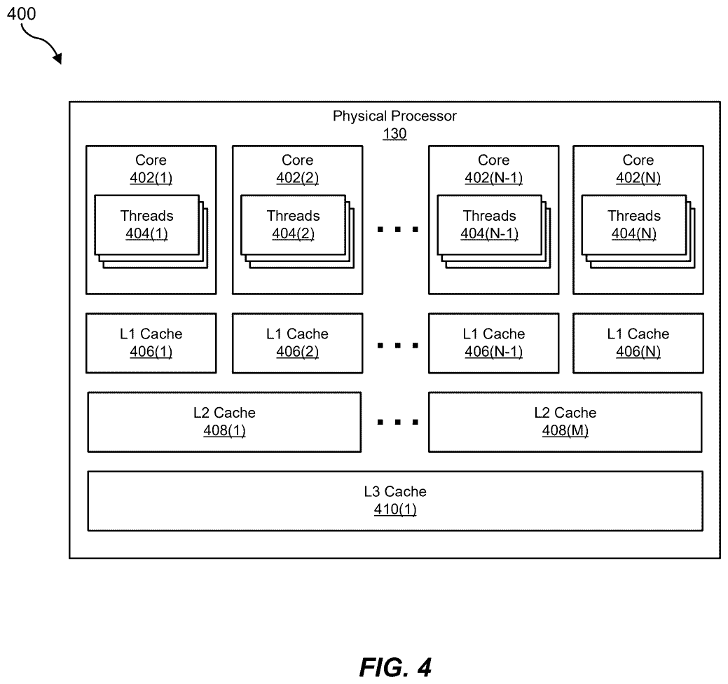

FIG. 4 depicts an example block diagram of a processor architecture 400 that may be utilized in one or more embodiments of the present disclosure to execute parallelization strategies for embedding operations in a DLRM. The processor architecture 400 includes multiple cores 402, threads 404, and hierarchical levels of cache memory, including L1 cache 406, L2 cache 408, and L3 cache 410. This architecture facilitates efficient execution of computational workloads associated with DLRMs by leveraging parallelism and optimizing memory access.

The physical processor 130 includes a plurality of processing cores 402(1) through 402(N), where each core may execute multiple threads 404(1) through 404(N). Threads 404 represent independent execution paths within each core, allowing the processor to handle multiple computational tasks simultaneously. In the context of a parallelization strategy, each thread may process a portion of an embedding table or manage specific tasks such as index lookups, pooling operations, or memory prefetching. For example, in a TT strategy, one thread may be assigned to each embedding table, leveraging the private caches of individual cores, such as L1 caches 406, to enhance memory locality. Alternatively, HT may allow threads within a core or across cores to share workloads for larger embedding tables, improving load balancing and cache reuse. The architecture supports dynamic thread assignment, enabling idle threads to adopt tasks from overloaded threads through work-stealing mechanisms, as employed in CGTT strategies.

The processor architecture includes a hierarchical cache system designed to minimize latency and maximize memory access efficiency. Each core 402 has a dedicated L1 cache 406, which provides ultra-low-latency access to frequently used data and is particularly effective for threads 404 processing indices and batch offset arrays associated with high-reuse embedding tables. The L2 caches 408, shared among threads 404 across multiple cores 402, enable efficient communication and data sharing between threads and store embeddings or intermediate results reused during pooling operations. The L3 cache 410, shared across all cores 402, reduces memory access latency for embedding tables accessed by multiple cores or threads. In parallelization strategies such as table grouping with HT, the L3 cache 410 may store embeddings from large, frequently accessed tables to minimize inter-core memory contention.

The processor architecture 400 may support NUMA, where cores 402 are grouped into distinct nodes, each with its own local memory. NUMA-aware parallelization strategies may bind threads 404 and allocate memory within the same NUMA node to minimize cross-node memory access latency. For example, threads 404 processing a specific embedding table may be assigned to cores 402 within a single NUMA node, while embeddings and indices for a table may be allocated to the local memory of the corresponding NUMA node to optimize memory locality.

The processor architecture 400 is designed to handle heterogeneous workloads associated with embedding tables of varying sizes, pooling factors, and access patterns. For large embedding tables accessed frequently, such as those following a power-law distribution, the architecture supports distributed processing across multiple cores 402 to ensure high throughput. For smaller tables or those accessed infrequently, threads 404 may operate in isolation, avoiding inter-core contention and maximizing cache utilization.

In some embodiments, the processor architecture 400 may include hardware accelerators or specialized processing units, such as GPUs or TPUs, to offload computationally intensive tasks. For example, embeddings with low reuse rates may be processed on accelerators, while high-reuse embeddings are handled by general-purpose cores 402.

The architecture supports additional optimization techniques employed by parallelization strategies, such as data prefetching, where threads 404 prefetch indices, embedding rows, or batch offset arrays into local caches, such as L1 caches 406 or L2 caches 408, to reduce memory latency during computation. Cache partitioning may dedicate portions of the cache, such as L3 cache 410, to specific threads or workloads to prevent contention and ensure high data reuse rates. Load balancing ensures that workloads are dynamically redistributed across cores 402 and threads 404 to minimize idle time and achieve balanced resource utilization.

The processor architecture 400 is scalable to support DLRMs exceeding terabyte-scale embedding tables. By leveraging multi-socket systems, hierarchical cache structures, and NUMA-aware resource allocation, the architecture ensures that computational and memory resources are utilized efficiently even as model size and complexity increase. FIG. 4 provides a robust foundation for implementing the parallelization strategies described in the present disclosure. By utilizing a HT model, optimized cache usage, and NUMA-aware techniques, the processor architecture achieves high performance and scalability for embedding operations in DLRMs. This enables efficient processing of large-scale input data, meeting stringent quality-of-service requirements in modern recommendation systems.

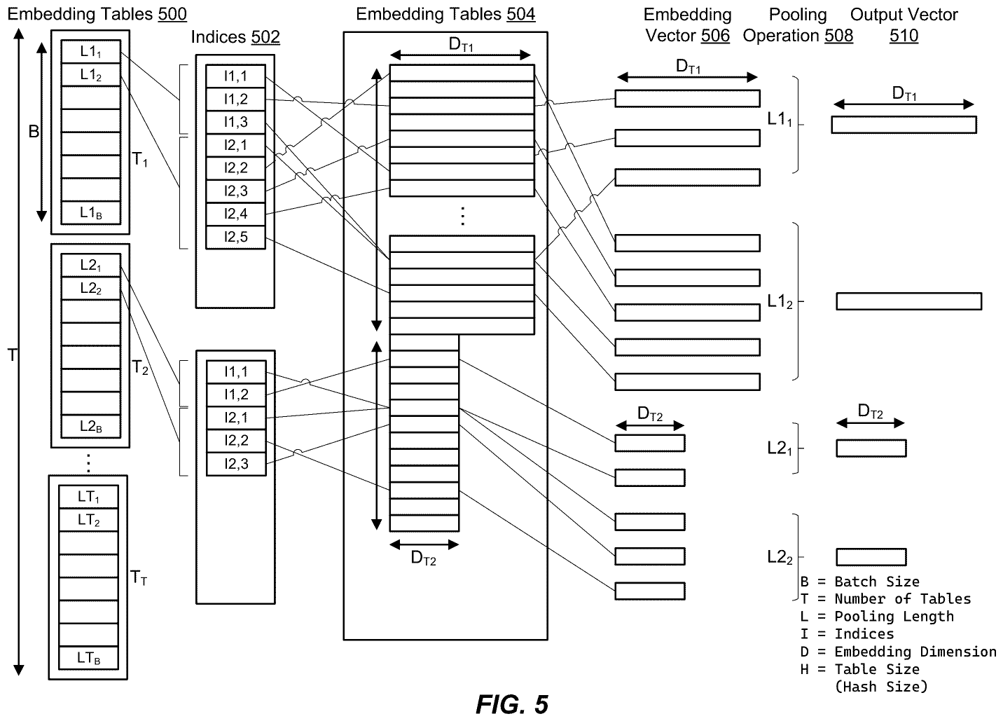

FIG. 5 illustrates an embedding bag operation used in a DLRM. The operation begins with embedding tables 500, which are shown as a series of tables labeled from T₁ to T_{T}, where T denotes the total number of tables. Each table, such as T₁ or T₂, contains multiple embeddings represented by rows L_{1,1} to L_{1,B} for table T₁, L_{2,1} to L_{2,B} for T₂, and so on, where B represents the batch size. Each row corresponds to a fixed-length vector, the dimensions of which are indicated as D_{T}_{₁}, D_{T}_{₂}, etc., where D_{T} is the embedding dimension for a given table.

Indices 502 represent the inputs to the embedding operation, mapping the categorical input features to the corresponding rows in the embedding tables. For example, indices such as I_{1,1}, I_{1,2}, I_{2,1}, I_{2,2}, and so on, point to specific rows in tables T₁ and T₂, retrieving the embeddings corresponding to the input data.

Embedding tables 504 depict the process where the indices 502 are used to access specific rows from the embedding tables. For example, I_{1,1} accesses a specific row in T₁, and I_{2,1} accesses a specific row in T₂. This operation retrieves embedding vectors, denoted as L_{1,1}, L_{1,2}, L_{2,1}, L_{2,2}, etc. The rows retrieved are represented by embedding vectors 506, each with dimensions corresponding to the embedding table from which they are retrieved, such as D_{T}_{₁} or D_{T}_{₂}.

The pooling operation 508 aggregates the embedding vectors 506 retrieved from the tables. Pooling operations may include summation, averaging, or other types of mathematical operations that combine the embedding vectors into a single output vector per input feature. For example, the vectors L_{1,1} and L_{1,2} may be summed to produce an aggregated embedding vector for T₁, and L_{2,1} and L_{2,2} may be summed for T₂.

The result of the pooling operation 508 is a set of output vectors 510. Each output vector corresponds to an aggregated representation of the embeddings retrieved from a specific table. The dimensions of the output vectors match the embedding dimensions of the corresponding tables, such as D_{T}_{₁} for T₁ and D_{T}_{₂} for T₂. These output vectors are then used as inputs for subsequent layers in the DLRM.

The variables and labels in the figure represent essential parameters and dimensions: B indicates the batch size, T denotes the number of tables, L specifies the pooling length, I refers to indices, D defines the embedding dimensions, and H indicates the table size or hash size. Together, these elements define the flow of the embedding bag operation, from input indices to the generation of output vectors, optimizing the computation of embedding vectors for use in recommendation systems.

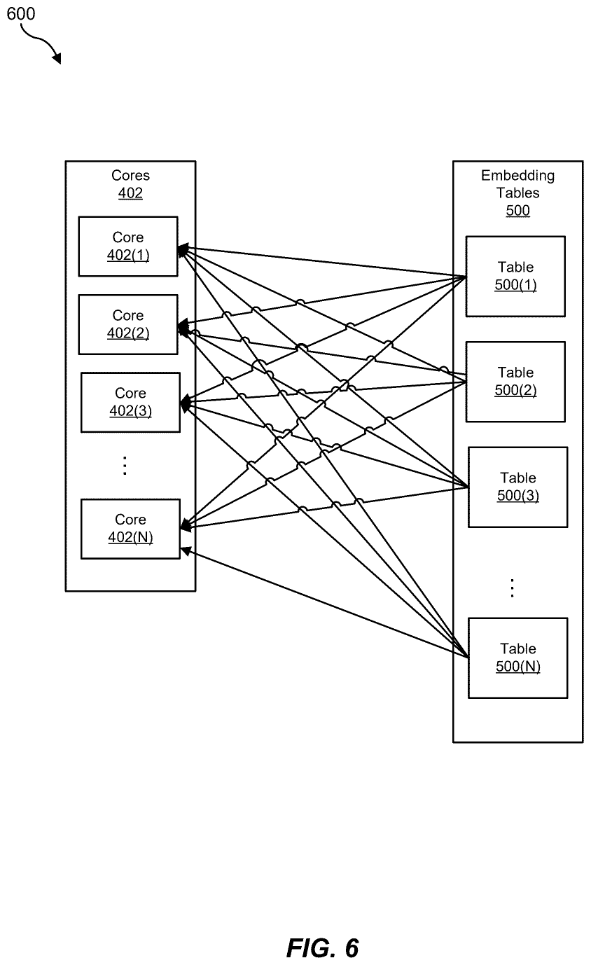

Implementing module 108 may apply a variety of parallelization strategies to process embedding tables 144. FIG. 6 illustrates a block diagram 600 that demonstrates how implementing module 108 applies process threading and batch threading strategies to optimize embedding operations in DLRMs. These parallelization strategies ensure efficient utilization of computational and memory resources, enabling the system to handle diverse workloads with high throughput and low latency.

In the process threading strategy, computational cores 402 are dynamically assigned to process one or more embedding tables 500. For example, core 402(1) may process table 500(1), core 402(2) may process table 500(2), and so forth. This mapping allows parallelization across tables, with larger tables distributed across multiple cores to balance workloads. For example, embedding tables with higher row counts or larger embedding dimensions may require more computational resources, and this strategy ensures that cores are effectively utilized without bottlenecks or idle resources. The process threading strategy is particularly suited for heterogeneous workloads, where tables differ significantly in size, access patterns, or reuse rates.

In some embodiments, process threading leverages NUMA node binding to further optimize execution. By assigning processes to specific NUMA nodes and aligning memory allocation with associated cores, this approach minimizes cross-node communication overhead, reduces latency, and enhances memory locality. Each process operates independently, efficiently utilizing the cache and memory hierarchy of its assigned NUMA node. This is especially beneficial for workloads with high memory bandwidth requirements, such as large-scale embedding operations.

The batch threading strategy focuses on intra-table parallelism by partitioning embedding tables into smaller subsets or batches. Each batch represents a subset of rows, and different cores concurrently process these batches. For example, core 402(1) may process one batch from Table 500(1), while core 402(2) processes a different batch from the same table. This strategy enables finer-grained workload distribution, allowing computations such as embedding lookups, pooling, and aggregation to be performed simultaneously across cores. Batch threading is particularly effective for large tables with high reuse rates or dense access patterns, as it optimizes cache utilization and reduces computational overhead.

The batch threading strategy further enhances resource efficiency by dynamically swapping tables in and out of caches during processing, ensuring that only active tables occupy fast memory. This minimizes contention and maximizes locality, enabling efficient handling of large embedding tables and datasets. The parallel execution of pooling operations, such as summation or averaging, within each batch accelerates the generation of output vectors, supporting high-throughput processing for DLRMs.

The combination of process threading and batch threading provides a flexible and scalable framework for parallelization. Process threading is well-suited for smaller tables or workloads with infrequent access, while batch threading enables collaborative processing for larger tables. Together, these strategies dynamically balance workloads, reduce latency, and ensure optimal resource utilization, as depicted in FIG. 6. By leveraging multi-level parallelism, the system meets the performance and scalability requirements of modern recommendation systems, efficiently processing large-scale input data with low latency and high throughput.

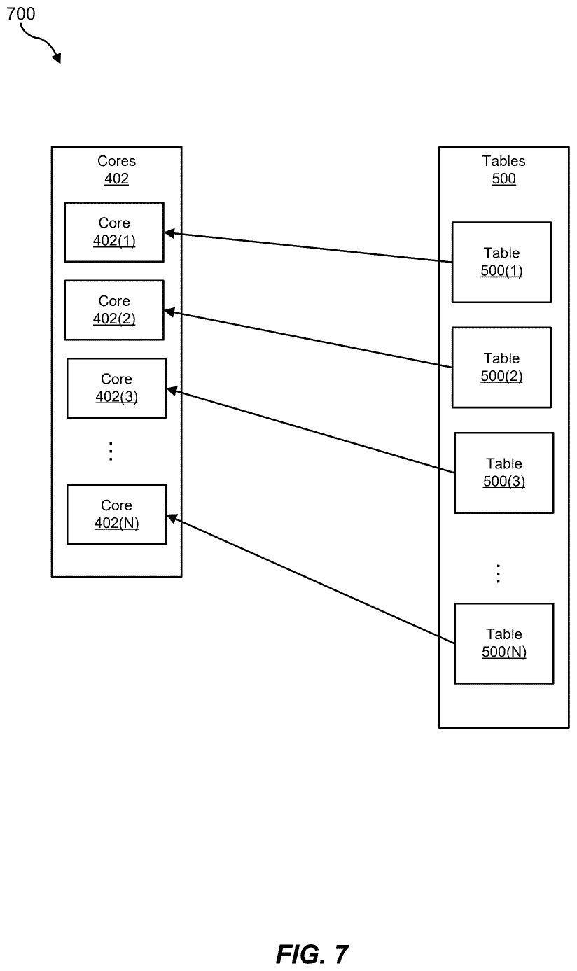

Additionally or alternatively, implementing module 108 may apply a TT parallelization strategy. FIG. 7 shows a block diagram 700 that illustrates a TT parallelization strategy, a method of distributing computational workloads across processing cores in a DLRM. This strategy optimizes the parallelization of embedding operations by assigning individual embedding tables exclusively to specific computational cores.

In the TT strategy shown in FIG. 7, each computational core 402 is assigned to process a distinct embedding table 500. For example, core 402(1) is responsible for processing table 500(1), core 402(2) processes table 500(2), and so on, up to core 402(N), which processes table 500(N). This one-to-one mapping ensures that each core works independently on a specific embedding table, thereby reducing inter-core communication and contention for shared resources such as caches or memory.

Each embedding table 500 contains embeddings that need to be retrieved and processed based on input indices. By dedicating a core to a specific table, the TT strategy ensures that the memory accesses associated with a particular table are localized to the cache hierarchy of that core. This improves memory locality and reduces latency, as the embeddings and indices are reused within the same core's private or shared cache, minimizing access to slower, off-core memory.

The TT strategy is particularly effective in scenarios where the embedding tables are roughly balanced in size and computational workload. For example, if the tables have similar numbers of rows, embedding dimensions, and access patterns, this strategy ensures an even distribution of work across the cores, maximizing utilization and throughput.

However, if the embedding tables exhibit heterogeneity—such as differences in size, access frequency, or reuse rates—this strategy can lead to imbalances. Larger tables or those accessed more frequently may overwhelm their assigned cores, resulting in underutilization of other cores. In such cases, hybrid strategies, such as HT or dynamic workload balancing, may be employed to address these imbalances.

FIG. 7 demonstrates how TT simplifies parallelization by isolating the processing of each table to a single core. This isolation reduces synchronization overhead, as cores do not need to coordinate their operations with others while processing their assigned tables. It also ensures that computational resources, such as threads and caches, are dedicated to the specific workload of each table, optimizing performance for DLRMs with relatively uniform table characteristics.

The TT strategy shown in FIG. 7 is particularly well-suited for applications where the embedding tables are independent of one another and do not require significant inter- table interactions during computation. By leveraging the independence of tables, this strategy facilitates efficient parallel processing, enabling high throughput and low latency for embedding operations in recommendation systems.

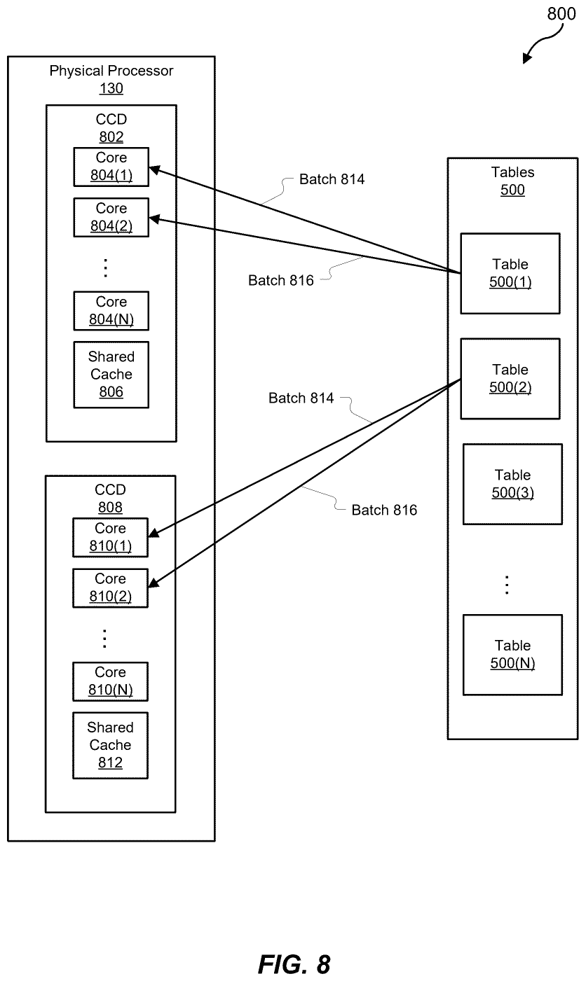

Additionally or alternatively, implementing module 108 may apply a hierarchical parallelization strategy. FIG. 8 includes a block diagram 800 that illustrates a hierarchical threading parallelization strategy. This strategy optimizes embedding table processing in DLRMs by leveraging both table-level and batch-level parallelism across a processor's cache and core hierarchy.

In hierarchical threading, embedding tables 500 are pinned to a chiplet or core complex die (CCD), such as CCD 802 or CCD 808, based on the hierarchical structure of the processor's cache and memory access patterns. Each CCD contains multiple cores (e.g., cores 804(1), 804(2), and 804(N) within CCD 802, and cores 810(1), 810(2), and 810(N) within CCD 808), which share a local cache (e.g., shared cache 806 for CCD 802 and shared cache 812 for CCD 808).

The hierarchical threading strategy operates by splitting each embedding table into smaller batches (e.g., Batch 814 and Batch 816), and these batches are distributed across cores within the same CCD for processing. The distribution is managed such that all cores within a CCD work on portions of the same table, benefiting from shared cache locality. For example, Batch 814 of Table 500(1) is processed by Core 804(1) and Core 804(2) within CCD 802, while another batch of the same table (Batch 816) may be processed by cores within CCD 808. In some examples, the HT strategy includes partitioning workloads into equal-sized segments for distribution across multiple cores to achieve balanced processing loads.

This HT mechanism provides several advantages. First, by pinning tables to specific CCDs, the strategy minimizes cross-CCD memory accesses, reducing latency and avoiding contention for interconnect bandwidth. Second, shared cache utilization: the shared cache within each CCD (e.g., 806 and 812) stores frequently accessed embeddings and indices, allowing cores to quickly access shared data without requiring off-chip memory access. Third, intra-table parallelism: within each CCD, the cores execute batch-level threading, where different cores process distinct batches of the same embedding table concurrently. This ensures efficient distribution of work across the cores. Additionally, the hierarchical threading strategy can dynamically adjust the assignment of tables and batches to cores and CCDs based on workload characteristics, such as table size, reuse patterns, and pooling factors.

An additional parallelization strategy that may be implemented, in some ways similar to the hierarchical threading strategy, may be a Core Group Table Threading (CGTT) strategy. CGTT represents an advanced parallelization strategy that optimizes computational resource utilization by dynamically assigning workloads for each embedding table to any available core within a common core complex (CCX). This approach leverages a shared task queue to facilitate dynamic load balancing and enables efficient work stealing among idle cores within the same CCX. By implementing CGTT, the system addresses challenges associated with static workload allocation, such as uneven distribution of tasks and underutilization of processing cores, which are common in traditional parallelization techniques.

The CGTT strategy operates by associating a shared task queue with each CCX, which contains work units corresponding to portions of embedding tables that need processing. Each core within the CCX monitors this queue and retrieves work units as needed. If a core completes its assigned tasks while other cores are still processing, it can dynamically “steal” tasks from the queue, thereby redistributing workloads in real time and improving overall efficiency. This dynamic allocation ensures that all cores within the CCX are effectively utilized, reducing idle time and balancing computational loads across the system.

An additional advantage of CGTT lies in its capability to enhance memory locality and cache efficiency. By confining the processing of embedding tables to cores within the same CCX, the strategy minimizes memory access latencies associated with cross-CCX communication. Embedding table data and intermediate results are stored in the shared cache of the CCX, enabling rapid access and reuse by all cores processing related tasks. This local caching reduces contention for slower off-core memory resources and optimizes the reuse of frequently accessed data, particularly for embedding tables with high access frequencies or pooling factors.

The implementation of CGTT is particularly advantageous for deep learning recommendation models (DLRMs) that exhibit heterogeneous workloads, where embedding tables vary significantly in size, access patterns, and reuse rates. In such cases, CGTT dynamically adjusts to these variations by distributing work units proportionally to the computational demand of each table. Larger tables or those with more complex access patterns are processed using multiple cores, while smaller tables are efficiently handled by individual cores within the CCX. This adaptability ensures that computational resources are allocated in a manner that aligns with the workload characteristics, enhancing throughput and reducing latency.

By integrating CGTT, the system also supports scalable performance across multi-processor configurations. For DLRMs deployed in environments with multiple CCXs or processors, CGTT can be extended to operate in a hierarchical fashion, where workloads are first distributed among CCXs, and then dynamically allocated to individual cores within each complex. This hierarchical approach ensures that the benefits of CGTT are preserved even as the scale of the system increases, enabling efficient processing of large-scale models and datasets.

In summary, CGTT enhances the parallelization of embedding table operations by dynamically balancing workloads, optimizing memory access patterns, and ensuring efficient utilization of processing cores within a CCX. This strategy overcomes the limitations of static workload allocation methods, providing a robust solution for managing the diverse and demanding workloads characteristic of modern DLRMs. The ability of CGTT to dynamically adapt to workload variations and optimize resource allocation at the core and cache level positions it as a critical component of an efficient, scalable system for deep learning-based recommendation tasks.

An additional or alternative parallelization strategy that may be applied may be table grouping with hierarchical threading (TG+HT). TG+HT addresses the challenges posed by the heterogeneous workloads of embedding tables in deep learning recommendation models (DLRMs). This strategy is designed to achieve optimal load balancing, memory efficiency, and computational throughput by dynamically distributing workloads based on the unique characteristics of each table, including size, pooling factor, and memory access patterns. Unlike traditional approaches that allocate computational resources uniformly across tables, TG+HT employs a nuanced methodology to group tables and allocate resources in proportion to their workload demands, thereby mitigating performance bottlenecks.

In this approach, embedding tables are first analyzed to determine key workload characteristics, such as the pooling factor, which dictates the extent of aggregation operations required, and memory access frequency, which influences data locality and cache utilization. Tables with large pooling factors and infrequent memory accesses are identified as low-hot, exhibiting long reuse distances. These tables often require significant computational resources and are well-suited for hierarchical threading. Conversely, tables with smaller pooling factors and frequent memory accesses are classified as high-hot, characterized by short reuse distances, and are assigned to single-core table threading for optimal performance.

For low-hot tables, hierarchical threading leverages multiple cores within a common core complex (CCX) to process workloads concurrently. The workload for each table is partitioned into segments, and these segments are distributed across the cores in the CCX. This distribution ensures that computational tasks are balanced among cores while taking advantage of shared cache hierarchies to reduce memory access latency. The threads processing these segments operate collaboratively, employing techniques such as task stealing to dynamically redistribute tasks and prevent idle cores.

High-hot tables, due to their frequent access and short reuse distances, are processed using single-core threading to maximize memory locality and minimize cache thrashing. By isolating these workloads to individual cores, the strategy ensures efficient cache utilization and eliminates contention for shared resources, enhancing overall processing efficiency.

Table grouping with hierarchical threading is particularly effective in handling embedding tables that exhibit a power-law distribution of access patterns. In such cases, a small subset of tables often dominates memory access and computational demands. This strategy ensures that these high-demand tables receive adequate computational resources, while smaller or less frequently accessed tables are processed efficiently without overprovisioning resources. Additionally, TG+HT dynamically adapts resource allocation during runtime to accommodate variations in workload characteristics, ensuring sustained performance under dynamic input conditions.

In some embodiments, TG+HT may leverage quantitative metrics to dynamically evaluate and allocate resources to embedding tables based on their workload characteristics. Key metrics include pooling factors, memory access frequencies, and reuse patterns. Pooling factors determine the extent of aggregation operations for each table, directly impacting computational demands. Memory access frequencies indicate the intensity of interactions with the table, while reuse patterns measure the locality and temporal proximity of these accesses. By analyzing these metrics, TG+HT identifies high-demand tables that require extensive computational resources and low-demand tables that can be processed with minimal overhead.

A significant advantage of TG+HT lies in its adaptability to power-law distributions of access patterns, where a small subset of tables accounts for the majority of memory accesses. This behavior, common in DLRMs, necessitates prioritizing resources for these high-demand tables to prevent bottlenecks. For example, tables with access frequencies within the top decile may be allocated multiple cores and integrated into a hierarchical threading framework, while less frequently accessed tables are processed using single-core table threading.

This allocation ensures that resources are distributed proportionally to workload demands, avoiding under-or overprovisioning for specific tables.

The TG+HT strategy also incorporates advanced cache utilization techniques, optimizing memory access across L1, L2, and L3 cache hierarchies. High-reuse tables, which exhibit frequent and repetitive access patterns, benefit from placement in private or shared caches at the core or CCX level. For instance, indices and embedding vectors of high-reuse tables are prefetched into L2 or shared L3 caches, minimizing latency during pooling operations. Conversely, low-reuse tables, characterized by sporadic access, are dynamically loaded into local caches only during processing, ensuring efficient memory usage without displacing high-priority data.

To further enhance performance, TG+HT dynamically adapts resource allocation during runtime based on observed performance metrics. This adaptation allows the system to respond to changes in workload characteristics, such as shifting access patterns or increased dataset sizes. For example, threads initially assigned to high-demand tables may be reassigned to lower-demand tasks as the computational intensity of the high-demand tables diminishes. This dynamic redistribution prevents idle cores and maintains balanced utilization across the processor.

Another critical feature of TG+HT is its NUMA-aware resource allocation, which minimizes cross-node memory access latencies. Threads processing embedding tables are bound to NUMA nodes containing the associated data, ensuring memory locality and reducing inter-node contention. For high-demand tables spanning multiple NUMA nodes, TG+HT partitions workloads to confine memory access within each node, preserving the benefits of shared local caches and reducing latency. Additionally, embedding tables are aligned with memory blocks to optimize NUMA locality during initialization, further streamlining access patterns.

Collaborative threading mechanisms, such as work stealing, play a pivotal role in TG+HT's efficiency. Threads processing low-hot tables within a CCX dynamically redistribute tasks among idle cores to prevent resource underutilization. For instance, if a core completes its assigned batch of tasks, it can “steal” work from other cores within the same CCX, balancing the workload dynamically. This collaboration ensures that all cores remain active, maximizing throughput and minimizing latency for large-scale embedding operations.

Testing and performance evaluations on large-scale datasets and modern multi-core architectures have demonstrated the efficacy of TG+HT. For example, benchmarks conducted on platforms with multiple CCXs indicate a significant increase in measured bandwidth, especially for high-reuse embedding tables, where TG+HT leverages cache hierarchies to their fullest potential. Early results also suggest reduced latency for power-law distributed workloads, with TG+HT achieving up to 50% faster processing times compared to static parallelization strategies.

By incorporating these advanced techniques and dynamic optimizations, TG+HT not only addresses the inherent challenges of embedding table heterogeneity but also ensures scalability for increasingly complex DLRMs. This strategy significantly enhances the efficiency and responsiveness of recommendation systems, meeting stringent quality-of-service requirements while enabling real-time operation on large datasets. TG+HT represents a transformative approach to embedding table parallelization, balancing computational loads, optimizing memory access, and delivering unparalleled performance for modern recommendation systems.

The integration of TG+HT into the parallelization strategy significantly improves the performance of DLRMs by optimizing cache usage, balancing computational loads, and scaling efficiently across modern multi-core and multi-socket architectures. By tailoring resource allocation to the specific demands of each table, this approach enhances throughput, reduces latency, and ensures that DLRMs can meet stringent quality-of-service requirements in real-time recommendation systems. This comprehensive strategy transforms the efficiency of embedding operations, enabling recommendation systems to handle increasingly complex models and larger datasets with precision and scalability.

In some examples, the parallelization strategy may incorporate advanced techniques to optimize the performance of embedding bag operations within deep learning recommendation models (DLRMs). These techniques include the utilization of optimized kernels and adaptive threading models that dynamically respond to workload characteristics.

To improve the efficiency of embedding bag operations, the parallelization strategy employs optimized kernels designed to exploit hardware-level parallelism. These kernels leverage vectorized instructions, such as SIMD (Single Instruction, Multiple Data) or AVX (Advanced Vector Extensions), to perform multiple computations simultaneously. For example, during the aggregation phase of embedding bag operations, summation or pooling functions are executed using vectorized arithmetic, allowing for the processing of multiple elements in a single instruction cycle. This reduces the overall computational latency and improves throughput. Additionally, optimized kernels minimize store operations by directly writing aggregated results into memory buffers, bypassing intermediate writes whenever feasible. This reduction in memory traffic further enhances the system's efficiency, particularly for workloads involving high-dimensional embedding vectors.

The parallelization strategy also dynamically selects and adjusts threading models to accommodate variations in workload characteristics, such as pooling factors, memory access frequencies, table sizes, and observed performance metrics. For instance, embedding tables with high pooling factors, which require extensive aggregation, are processed using hierarchical threading models that distribute workloads across multiple cores in a cache-aware manner. Conversely, embedding tables with low pooling factors or sparse access patterns may be assigned to single-threaded execution contexts to maximize memory locality and minimize cache contention.

Adaptive tuning of threading parameters is another critical aspect of the disclosed methods. During runtime, the system continuously monitors workload characteristics and adjusts parameters such as thread allocation, batch sizes, and cache prefetching strategies. For example, if observed performance metrics indicate an imbalance in core utilization, the system may redistribute tasks by increasing the number of threads processing larger embedding tables or reallocating underutilized cores to handle smaller, less demanding tables. Similarly, memory access patterns are analyzed to optimize cache utilization by prefetching frequently accessed embedding rows into higher levels of the cache hierarchy, reducing latency for subsequent operations.

Dynamic adjustments are informed by metrics such as average processing time per batch, cache hit rates, and thread idle times. These metrics allow the system to identify bottlenecks and implement corrective measures in real-time. For example, when processing large datasets with heterogeneous embedding tables, the system may switch from a table threading model to a hybrid threading model, combining batch-level and table-level parallelism to achieve optimal load balancing and memory efficiency.

The integration of optimized kernels and adaptive threading ensures that the parallelization strategy not only delivers high computational throughput but also adapts seamlessly to diverse and dynamic workloads. These advancements enable the system to scale efficiently across modern multi-core architectures and meet the stringent performance requirements of real-time recommendation systems. By tailoring computational resources and execution models to the specific demands of embedding operations, the disclosed methods transform the efficiency and scalability of DLRMs in data-intensive environments.

Returning to FIG. 3, at step 340, one or more of the systems described herein may process the embeddings based on the input data in accordance with the parallelization strategy, the processing including aggregating embeddings accessed from the plurality of embedding tables into aggregated embeddings 206.

Returning to FIG. 3, at step 340, one or more systems described herein may process embeddings based on the input data in accordance with the parallelization strategy selected and initialized during prior steps. This processing involves the retrieval, manipulation, and aggregation of embeddings from a plurality of embedding tables into aggregated embeddings 206, which serve as intermediate results for further stages in the DLRM pipeline.

To execute this step, the processing module 110 may first retrieve embeddings from embedding tables using the indices and batch offset arrays provided as input. The embeddings correspond to rows in the embedding tables, where each row represents a fixed-length numerical vector associated with a unique categorical feature (e.g., a user ID or product ID). These embedding lookups are distributed across computational resources (e.g., processor cores) in accordance with the chosen parallelization strategy. For example, a process threading strategy may assign individual embedding tables to specific cores, while a batch threading strategy may partition the workload within a table across multiple cores.

Once retrieved, the embeddings undergo an aggregation operation, which combines multiple embedding vectors into a single output vector for each input feature or record. This aggregation is performed using one or more pooling functions, such as summation, averaging, or maximum selection. For example, if multiple embeddings are retrieved for a given input record, the summation pooling function combines these embeddings by adding corresponding elements across the vectors, producing a single aggregated embedding that represents the combined information.

The aggregation process is optimized for performance and memory efficiency. The system may use parallelized pooling operations to process multiple records or embeddings simultaneously, leveraging vectorized instructions and cache-local memory access. The specific parallelization strategy further enhances the efficiency of the aggregation. For example, HT may distribute the aggregation workload across multiple levels of the processor's cache and core hierarchy, while NUMA-aware strategies minimize latency by binding memory accesses to local nodes.

During this step, prefetching techniques may also be employed to fetch embeddings into local caches ahead of processing, ensuring low-latency access. Additionally, memory management techniques may dynamically allocate resources to frequently accessed embedding tables, optimizing throughput for high-reuse patterns. For embedding tables with sparse access or low reuse rates, the system may process these embeddings on specialized hardware accelerators, further enhancing performance. Such techniques may include strategies to reduce cache contention, maximize memory locality, and improve throughput during parallelized embedding operations.

To further enhance memory locality and optimize performance in systems with Non-Uniform Memory Access (NUMA) architectures, the parallelization strategy may implement NUMA-aware techniques specifically tailored for embedding table workloads. In particular, threads can be dynamically bound to NUMA nodes based on workload characteristics such as reuse patterns, pooling factors, and memory access frequencies, ensuring that threads remain localized to the memory regions associated with their assigned embedding tables to minimize cross-node memory latency. Memory allocation may prioritize tables with high reuse rates, storing them preferentially in local caches or memory regions directly associated with the corresponding processing threads to maximize memory access efficiency. Additionally, workloads for embedding tables can be redistributed dynamically across NUMA nodes in response to real-time performance metrics, such as thread idle times, cache hit rates, or memory bandwidth utilization, ensuring balanced computational loads while maintaining memory locality. Performance metrics may be gathered using system profiling tools or hardware performance counters, enabling real-time adjustments to thread and memory allocations. Prefetching techniques can also be employed, leveraging predictive models of access patterns, including power-law distributions, to prefetch data from high-reuse embedding tables into local caches, thereby reducing latency and contention during computation. These NUMA-aware optimizations are particularly effective in addressing the heterogeneous access patterns and high data reuse typical of embedding table workloads in deep learning recommendation models.

The result of this step is a set of aggregated embeddings 206. These embeddings are dense numerical vectors that summarize the relevant features extracted from the input data and embedding tables. Aggregated embeddings 206 are passed to subsequent layers of the DLRM pipeline, such as interaction layers or fully connected layers, for further processing and prediction tasks.

By integrating parallelization strategies, efficient pooling operations, and advanced memory management, step 340 ensures that the system processes large-scale embedding workloads with high throughput and low latency, meeting the stringent requirements of modern recommendation systems.

Returning to FIG. 3, step 350 builds directly on the computations performed in step 340. At step 340, processed embeddings are aggregated and transformed to create intermediate representations that serve as inputs for the subsequent output generation phase. At step 350, one or more of the systems described herein may generate, for further processing, output data based on the processed embeddings. For example, generating module 112 may generate output vectors 208 by leveraging the intermediate results from step 340.

The output generation phase refines and prepares the processed embeddings into final output vectors suitable for downstream tasks. Generating module 112 may apply additional pooling operations, such as summation, averaging, or weighted pooling, to further combine embeddings associated with specific input features. In some embodiments, these output vectors are normalized using techniques such as L2 normalization, min-max scaling, or batch normalization to ensure consistent feature magnitudes, which improves stability and performance in subsequent stages of the pipeline.

Step 350 also optimizes the generation process through techniques similar to those employed in step 340. These may include the use of hardware accelerators, vectorized instructions (e.g., AVX or SIMD), and caching strategies to prefetch frequently accessed embeddings and minimize memory latency. For example, embeddings with high reuse rates may be kept in fast caches, while those accessed less frequently are dynamically swapped in and out of memory as needed.

The output vectors generated at this step may be prepared for downstream computations such as feature interaction, ranking, or neural network inference. For instance, the output vectors may be concatenated or combined with other feature embeddings and passed through interaction layers that calculate pairwise or higher-order interactions between features. These interaction layers may involve dot products, polynomial expansions, or other mathematical transformations that enhance the model's predictive accuracy.

In distributed systems, generating module 112 may further partition the output vectors into smaller subsets for parallel processing across multiple nodes or cores. This segmentation allows the system to handle large-scale datasets efficiently, maintaining low latency and high throughput even in highly dynamic or resource-intensive environments.

In summary, step 350 represents a continuation of the computations performed in step 340, building on processed embeddings to generate final output vectors that are optimized for downstream tasks. Together, these steps enable the efficient handling of embedding operations, ensuring that DLRMs achieve high performance and scalability.

In some embodiments, one or more of the systems disclosed herein (e.g., one or more of modules 102) may detect reuse patterns in embedding table access to optimize memory performance by prefetching frequently accessed data into local caches. One or more of modules 102 may identify reuse patterns by analyzing the frequency and temporal distribution of accesses to specific embedding table rows or subsets. High-reuse patterns may indicate that certain rows or groups of rows are accessed repeatedly within a short time window, making them ideal candidates for caching in local memory.

To detect these patterns, one or more of modules 102 may monitor embedding table access logs during runtime, recording metrics such as access frequency, access intervals, and reuse distances for each table or row. Access frequency measures how often a specific embedding is retrieved over a period, while access intervals capture the time gaps between successive accesses to the same embedding. Reuse distance quantifies the number of unique embeddings accessed between repeated accesses to the same embedding. By evaluating these metrics, the system categorizes embeddings into high-reuse and low-reuse groups.

One or more of modules 102 may preemptively load high-reuse embeddings into faster memory tiers, such as L1, L2, or shared L3 caches, to minimize retrieval latency during computation. For example, embeddings with short reuse distances and high access frequencies are prioritized for placement in L1 or L2 caches, where they can be rapidly accessed by the processing cores. Conversely, embeddings with longer reuse distances may be allocated to shared L3 caches, ensuring availability while conserving faster cache resources for more frequently accessed data.

The prefetching mechanism operates dynamically, adjusting cache contents in response to changing reuse patterns. For instance, if the access frequency for a previously low-reuse embedding increases during execution, the system promotes it to a higher cache level. Similarly, embeddings that exhibit decreasing reuse rates are demoted or evicted from local caches to make room for higher-priority data. This dynamic cache management ensures that the most relevant embeddings are readily available to the processing cores, reducing memory latency and improving overall computational throughput.

Additionally, one or more of modules 102 may employ prefetching algorithms tailored to the characteristics of DLRMs. Sequential prefetching is used for embeddings with predictable access patterns, such as those accessed in batch operations. For embeddings with irregular or stochastic access patterns, the system leverages predictive algorithms based on historical access data to anticipate future retrievals and prefetch the corresponding embeddings. These algorithms are designed to minimize cache misses while avoiding excessive memory overhead or unnecessary prefetching.

The integration of reuse pattern detection and intelligent prefetching significantly enhances memory performance in DLRMs. By reducing the time required to access embeddings during parallelized operations, these techniques contribute to lower latency, higher throughput, and efficient resource utilization. This optimization is particularly critical for large-scale recommendation systems, where embedding tables often exceed the capacity of primary memory, and efficient cache management is essential for real-time processing.

In some embodiments, one or more of modules 102 may employ a micro-benchmarking framework to evaluate the performance of parallelization strategies under diverse reuse and workload conditions. These modules use the framework to analyze performance metrics such as computational throughput, memory access latency, cache hit rates, and load balancing efficiency. By systematically varying parameters like table size, pooling factors, memory access frequency, and reuse patterns, the modules assess how each parallelization strategy responds to specific workload scenarios.

The modules may generate synthetic datasets or select representative subsets of real-world data to simulate workloads with targeted characteristics. For example, the datasets may represent high-reuse workloads with frequent access to specific embedding table rows or low-reuse workloads with sparse and irregular access patterns. The modules then apply parallelization strategies, including process threading, batch threading, TT, CGTT, and TG+HT, to these workloads and measure their performance.

In the context of TG+HT, the modules evaluate performance by distinguishing between high-hot and low-hot tables. The modules quantify the benefits of hierarchical threading for low-hot tables with long reuse distances and measure the efficiency of single-core threading for high-hot tables with frequent access. Similarly, when applying CGTT, the modules assess the effectiveness of work-stealing mechanisms in redistributing workloads and minimizing idle core time under dynamic conditions.

To analyze hardware-specific configurations, the modules measure metrics such as L1/L2/L3 cache hit rates and inter-core communication overhead. By monitoring these metrics, the modules identify performance bottlenecks and opportunities to optimize cache utilization, NUMA node binding, and core assignments.

One or more of modules 102 use profiling tools and performance counters embedded in modern processors to collect real-time feedback on hardware utilization. These tools allow the modules to conduct a granular analysis of how different parallelization strategies interact with the computing architecture. The modules perform iterative benchmarking cycles to adapt strategies to new workload patterns and evolving system requirements, ensuring the strategies remain effective.

Using the insights from the micro-benchmarking framework, the modules may dynamically refine the parallelization strategies. For instance, they may prioritize specific workloads, reallocate resources to enhance efficiency, or adopt hybrid approaches that combine the strengths of multiple strategies. By providing a detailed performance analysis, the modules ensure that the system achieves optimal performance across a wide range of reuse and workload conditions, supporting scalability and adaptability for real-world applications.

As discussed throughout the instant disclosure, the disclosed systems and methods may provide one or more advantages over traditional options for processing embedding operations in DLRMs. Embodiments of this disclosure address inefficiencies associated with managing embedding tables, which often result in computational bottlenecks and resource underutilization in traditional systems. By introducing parallelization strategies such as process threading, batch threading, hierarchical threading, and NUMA-aware optimizations, these embodiments dynamically allocate computational resources to embedding tables based on their unique workload characteristics.

For example, larger embedding tables requiring significant computational resources can be processed across multiple cores, while smaller tables or those with infrequent access are assigned to single cores, ensuring a balanced distribution of workloads. These strategies minimize latency, reduce inter-core contention, and improve memory locality by leveraging techniques such as NUMA-aware binding, caching, and prefetching. Additionally, the disclosed systems and methods enable fine-grained workload distribution through batch-level parallelism, where embedding tables are partitioned into smaller subsets, allowing pooling and aggregation operations to be performed concurrently across multiple cores.

Embodiments of this disclosure further provide scalable solutions for handling the growing complexity and size of embedding tables in modern recommendation systems. By combining process-level and batch-level threading, these systems achieve high throughput and low latency, meeting the performance demands of real-time recommendations while effectively utilizing available hardware resources. Techniques such as hardware acceleration, vectorized instructions, and memory optimizations ensure that embedding operations are executed with maximum efficiency.

These advancements enable DLRMs to process increasingly large datasets and more complex models, resulting in higher accuracy and responsiveness in recommendation tasks. Moreover, by reducing computational overhead and optimizing memory utilization, embodiments of this disclosure improve the overall scalability and performance of recommendation pipelines, supporting applications in e-commerce, digital advertising, and personalized content delivery. These systems and methods transform the efficiency of embedding operations, ensuring that modern recommendation systems can meet the stringent quality-of-service requirements of real-world, data-intensive environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
initializing a deep learning recommendation model (DLRM) comprising a plurality of embedding tables, each embedding table comprising a plurality of embeddings;
receiving input data associated with accessing embeddings from the plurality of embedding tables;
applying a parallelization strategy to process the plurality of embedding tables, the parallelization strategy configured to improve performance by distributing computational workloads and optimizing memory access;
processing the embeddings based on the input data in accordance with the parallelization strategy, the processing comprising aggregating embeddings accessed from the plurality of embedding tables; and
generating, for further processing, output data based on the processed embeddings.

2. The method of claim 1, wherein the parallelization strategy comprises at least one of:
a table threading strategy, wherein each embedding table is assigned to a dedicated hardware context for processing;
a core group table threading (CGTT) strategy, wherein workloads for each embedding table are dynamically assigned to any core within a common core complex (CCX);
a hierarchical threading (HT) strategy, wherein workloads for embedding tables are divided into segments and distributed across multiple cores within a hierarchical threading model; and
a table grouping (TG) with HT strategy, wherein embedding tables are grouped based on workload characteristics, with larger tables assigned more computational resources and smaller tables processed using single-core table threading.

3. The method of claim 2, wherein:
the parallelization strategy comprises a CGTT strategy; and
the CGTT strategy comprises further employing a shared task queue to facilitate work stealing across idle cores within a CCX.

4. The method of claim 2, wherein:
the parallelization strategy comprises a HT strategy; and
the HT strategy further comprises partitioning workloads into equal-sized segments for distribution across multiple cores to achieve balanced processing loads.

5. The method of claim 2, wherein:
the parallelization strategy comprises a TG with HT strategy; and
the TG with HT strategy further comprises assigning computational resources to tables based on a combination of their pooling factor, size, and memory access frequency.

6. The method of claim 2, wherein:
the parallelization strategy comprises a TG strategy; and
the TG strategy allocates computational resources based on workload characteristics and further comprises:
identifying access frequencies of embedding tables that follow a power-law distribution, wherein a subset of tables is accessed significantly more frequently than others; and
allocating additional resources to tables with higher access frequencies to optimize computational throughput and balance workloads.

7. The method of claim 2, wherein the method further comprises partitioning embedding tables between processing resources based on reuse patterns, with tables having high reuse rates processed on general-purpose processors and those with low reuse rates processed on hardware accelerators.

8. The method of claim 1, wherein the parallelization strategy enhances memory locality through Non-Uniform Memory Access (NUMA)-aware techniques comprising at least one of:
binding threads to specific NUMA nodes based on dynamic workload characteristics to minimize cross-node memory latency;
allocating memory within NUMA nodes for embedding tables such that tables with high reuse rates are preferentially stored in local caches associated with corresponding processing threads;
dynamically redistributing embedding table workloads across NUMA nodes in response to real-time performance metrics while preserving memory locality to ensure balanced computational loads; and
prefetching embedding table data into local caches associated with NUMA nodes based on predictive models of access patterns, leveraging power-law distributions of access frequencies to prioritize high-reuse tables.

9. The method of claim 1, wherein the parallelization strategy utilizes optimized kernels for embedding bag operations, the optimized kernels configured to employ vectorized instructions and reduce store operations.

10. The method of claim 1, wherein the parallelization strategy comprises dynamically selecting and adjusting threading models and adaptively tuning threading parameters based on workload characteristics to optimize computational throughput and latency, the workload characteristics comprising at least one of:
pooling factors,
memory access frequencies,
table sizes, or
observed performance metrics.

11. The method of claim 1, further comprising detecting reuse patterns in embedding table access and optimizing cache utilization for frequently accessed data to enhance memory performance.

12. The method of claim 1, wherein the parallelization strategy minimizes inter-core cache contention to enhance memory access efficiency.

13. The method of claim 1, wherein the parallelization strategy is configured to scale across multi-socket systems and support large-scale deep learning recommendation models. 14 The method of claim 1, wherein the method further comprises employing a micro-benchmarking framework to evaluate performance of parallelization strategies under different reuse and workload conditions.

15. A system comprising:
at least one processor;
at least one computer-readable medium having encoded thereon instructions that, when executed by the at least one processor, cause the at least one processor to carry out a method, the method comprising:
initializing a deep learning recommendation model (DLRM) comprising a plurality of embedding tables, each embedding table comprising a plurality of embeddings;
receiving input data associated with accessing embeddings from the plurality of embedding tables;
applying a parallelization strategy to process the plurality of embedding tables, the parallelization strategy configured to improve performance by distributing computational workloads and optimizing memory access;
processing the embeddings based on the input data in accordance with the parallelization strategy, the processing comprising aggregating embeddings accessed from the plurality of embedding tables; and
generating, for further processing, output data based on the processed embeddings;
a memory device communicatively coupled to the at least one processor, the memory device configured to store:
the plurality of embedding tables; and
the input data;
a network interface configured to receive the input data from a remote source and transmit the output data to subsequent processing systems; and
a storage controller, communicatively coupled to the memory device, configured to manage efficient retrieval and caching of the embedding tables during execution of the parallelization strategy.

16. The system of claim 15, wherein the at least one processor is further configured to implement the parallelization strategy to improve performance by distributing computational workloads and optimizing memory access, the parallelization strategy comprising at least one of:
a table threading strategy, wherein each embedding table is assigned to a dedicated hardware context for processing, thereby leveraging private caches to maximize memory locality and reduce inter-core contention;
a core group table threading (CGTT) strategy, wherein workloads for each embedding table are dynamically assigned to any core within a common core complex (CCX), enabling a shared task queue and a work-stealing mechanism for balanced load distribution across cores;
a hierarchical threading (HT) strategy, wherein workloads for embedding tables are divided into smaller and equal size segments and distributed across multiple cores in a hierarchical threading model to optimize cache utilization at multiple levels of a cache hierarchy; or a table grouping (TG) with HT strategy, wherein embedding tables are grouped based on workload characteristics such as pooling factors, table sizes, and memory access patterns, allocating larger tables additional computational resources and smaller tables to single-core processing contexts for efficient resource utilization.

17. The system of claim 15, wherein the at least one processor is configured to implement a Non-Uniform Memory Access (NUMA) aware parallelization strategy that minimizes cross-node memory access latency by at least one of:
binding threads to specific NUMA nodes based on dynamic workload characteristics;
allocating memory within NUMA nodes for embedding tables such that tables with high reuse rates are preferentially stored in local caches associated with corresponding processing threads;
dynamically redistributing embedding table workloads across NUMA nodes in response to real-time performance metrics while preserving memory locality to ensure balanced computational loads; and
prefetching embedding table data into local caches associated with NUMA nodes based on predictive models of access patterns, leveraging power-law distributions of access frequencies to prioritize high-reuse tables.

18. A non-transitory computer-readable medium storing instructions that, when executed by one or more processors, cause the one or more processors to perform a method comprising:
initializing a deep learning recommendation model (DLRM) comprising a plurality of embedding tables, each embedding table comprising a plurality of embeddings;
receiving input data associated with accessing embeddings from the plurality of embedding tables;
applying a parallelization strategy to process the plurality of embedding tables, the parallelization strategy configured to improve performance by distributing computational workloads and optimizing memory access;
processing the embeddings based on the input data in accordance with the parallelization strategy, the processing comprising aggregating embeddings accessed from the plurality of embedding tables; and
generating, for further processing, output data based on the processed embeddings. 19 The non-transitory computer-readable medium of claim 18, wherein the instructions further cause the one or more processors to execute a parallelization strategy to optimize computational throughput and memory efficiency, the parallelization strategy comprising at least one of:
a table threading strategy, wherein individual embedding tables are assigned to specific threads, leveraging thread-local caches to enhance memory locality and reduce inter-thread interference;
a core group table threading (CGTT) strategy, wherein workloads for embedding tables are assigned dynamically within a common core complex (CCX), utilizing a shared task queue to facilitate dynamic load balancing through work stealing among idle cores;
a hierarchical threading (HT) strategy, wherein workloads for embedding tables are partitioned into smaller and approximately equal size segments and distributed across cores in a hierarchical structure to improve cache reuse and reduce memory latency; or
a table grouping (TG) with HT strategy, wherein embedding tables are categorized based on computational and memory characteristics, with pooling factors, table sizes, and access frequencies determining resource allocation, ensuring optimal load distribution across available cores.

20. The non-transitory computer-readable medium of claim 18, wherein the instructions further cause the one or more processors to implement a Non-Uniform Memory Access (NUMA)-aware parallelization strategy that minimizes cross-node memory access latency by at least one of:
binding threads to specific NUMA nodes based on dynamic workload characteristics;
allocating memory within NUMA nodes for embedding tables such that tables with high reuse rates are preferentially stored in local caches associated with corresponding processing threads;
dynamically redistributing embedding table workloads across NUMA nodes in response to real-time performance metrics while preserving memory locality to ensure balanced computational loads; and
prefetching embedding table data into local caches associated with NUMA nodes based on predictive models of access patterns, leveraging power-law distributions of access frequencies to prioritize high-reuse tables.
